(19) United States
(12) Patent Application Publication
(10) Pub. No.: US 2002/0152144 A1
(43) Pub. Date: Oct. 17, 2002

(54) Midi-enabled real-time market indicator

(75) Inventors: Robert J. Kamper, Round Rock, TX (US); Eyitope Oyinkan St. Matthew-Daniel, Austin, TX (US); Larry Don Swofford, Georgetown, TX (US)

Correspondence Address: Duke W. Yee, Carstens, Yee & Cahoon, LLP, P.O. Box 802334, Dallas, TX, 75380, US

(73) Assignee: International Business Machines Corporation, Armonk, NY

(21) Appl. No.: 09/833,415

(22) Filed: Apr. 12, 2001

(51) Int. Cl. G06F 17/60

(52) U.S. Cl. 705/35; 705/37

(57) ABSTRACT

A method for annunciating performance of an investment vehicle within a plurality of investment vehicles in a market is provided. A current performance indication of the investment vehicle within the plurality of investment vehicles is received. The current performance indication of the investment vehicle is matched to a predetermined audible signature. The predetermined audible signature is then transmitted based on results of the matching.

### BACKGROUND OF THE INVENTION

1. Technical Field

The present invention relates to an improved data processing system and in particular to a method and apparatus for sending messages in a data processing system. Still more particularly, the present invention provides a method and apparatus for using programmable sounds to track investment vehicles in real-time.

2. Description of Related Art

The Internet, also referred to as an “internetwork”, is a set of computer networks, possibly dissimilar, joined together by means of gateways that handle data transfer and the conversion of messages from the sending network to the protocols used by the receiving network (with packets if necessary). When capitalized, the term “Internet” refers to the collection of networks and gateways that use the TCP/IP suite of protocols.

The Internet has become a cultural fixture as a source of both information and entertainment. Many businesses are creating Internet sites as an integral part of their marketing efforts, informing consumers of the products or services offered by the business or providing other information seeking to engender brand loyalty. Many federal, state, and local government agencies are also employing Internet sites for informational purposes, particularly agencies which must interact with virtually all segments of society such as the Internal Revenue Service and secretaries of state. Providing informational guides and/or searchable databases of online public records may reduce operating costs. Further, the Internet is becoming increasingly popular as a medium for commercial transactions.

Currently, the most commonly employed method of transferring data over the Internet is to employ the World Wide Web environment, also called simply “the Web”. Other Internet resources exist for transferring information, such as File Transfer Protocol (FTP) and Gopher, but have not achieved the popularity of the Web. In the Web environment, servers and clients effect data transaction using the Hypertext Transfer Protocol (HTTP), a known protocol for handling the transfer of various data files (e.g., text, still graphic images, audio, motion video, etc.). The information in various data files is formatted for presentation to a user by a standard page description language, the Hypertext Markup Language (HTML). In addition to basic presentation formatting, HTML allows developers to specify “links” to other Web resources identified by a Uniform Resource Locator (URL). A URL is a special syntax identifier defining a communications path to specific information. Each logical block of information accessible to a client, called a “page” or a “Web page”, is identified by a URL. The URL provides a universal, consistent method for finding and accessing this information, not necessarily for the user, but mostly for the user's Web “browser”. A browser is a program capable of submitting a request for information identified by an identifier, such as, for example, a URL. A user may enter a domain name through a graphical user interface (GUI) for the browser to access a source of content. The domain name is automatically converted to the Internet Protocol (IP) address by a domain name system (DNS), which is a service that translates the symbolic name entered by the user into an IP address by looking up the domain name in a database.

The Internet also is widely used to transfer applications to users using browsers. With respect to commerce on the Web, individual consumers and business use the Web to purchase various goods and services. In offering goods and services, some companies offer goods and services solely on the Web while others use the Web to extend their reach.

In addition, vision impaired users of the Web often rely on tools, such as a talking Web browser. An example of a talking Web browser is the Home Page Reader (HPR), which is available from International Business Machines Corporation (IBM). HPR is a spoken on-ramp to the Information Highway for computer users who are blind or visually impaired. HPR provides Web access by quickly, easily, and efficiently speaking Web page information. HPR provides a simple, easy-to-use interface for navigating and manipulating Web page elements. Using the keyboard to navigate, a user who is blind or who has a visual impairment can hear the full range of Web page content provided in a logical, clear, and understandable manner.

One example of a mechanism used on the Web for electronic commerce is an equity exchange. An equity exchange, for example, is used for trading commodity items in highly liquid markets, such as stocks and other financial instruments. The primary purpose of the equity exchange is to determine the current market price based on demand and supply conditions. The exact mechanism used in a particular equity exchange varies from one exchange to another. For example, the New York Stock Exchange (NYSE) follows a specialist model while the National Association of Securities Dealers Automated Quotation (NASDAQ) uses multiple market makers. Both of these exchanges are continuous clearing models. In contrast, the American Stock Exchange uses periodic clearing, which is better suited for less liquid markets.

These equity exchanges are designed to handle a specific good or service, which in this example takes the form of a security or stock for a company. The present invention recognizes that, in the ever broadening reach provided by the Internet, buyers and sellers will desire to have a mechanism in which different types of products and services may be supported in an exchange type architecture. Yet, one problem with participating in an equity exchange is that the most recognizable method of keeping track of the value or status of a stock is by a visual means. Another method is the announcement of the current value or most recent change in an equity price, however, unless a participant pays constant attention to a particular equity price. The change in price does not necessarily give the needed information to the participant. Therefore, it would be advantageous to have an improved method and apparatus for annunciating an investment vehicle's performance by assigning an audible indication of the investment vehicle's performance to assist those with impaired vision as well as to provide audio channel information to those whose visual attention may be previously occupied at the time the information is delivered.

### SUMMARY OF THE INVENTION

The present invention provides a method for annunciating performance of an investment vehicle within a plurality of investment vehicles in a market. A current performance indication of the investment vehicle within the plurality of investment vehicles is received. The current performance indication of the investment vehicle is matched to a predetermined audible signature. The predetermined audible signature is then transmitted based on the results of the match.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a data processing system in which the present invention may be implemented;

FIG. 2 is a block diagram of a data processing system that may be implemented as a server in accordance with a preferred embodiment of the present invention;

FIG. 3 is a block diagram of a data processing system that may be implemented as a client in accordance with a preferred embodiment of the present invention;

FIG. 4 is an exemplary portfolio for establishing investment vehicle tracking parameters to be used in the tracking of the performance of an investment vehicle in accordance with a preferred embodiment of the present invention;

FIGS. 5A and 5B are exemplary block diagrams illustrating a process for annunciating performance of an investment vehicle in accordance with a preferred embodiment of the present invention;

FIG. 6 is a flowchart illustrating selection of investment vehicles and audible performance indicators in accordance with a preferred embodiment of the present invention;

FIG. 7 is a flowchart illustrating a process for annunciating investment vehicle performance in accordance with a preferred embodiment of the present invention; and

FIG. 8 is a flowchart illustrating of a process for selecting matching audible signatures in accordance with a preferred embodiment of the present invention.

### DETAILED DESCRIPTION OF THE PREFERRED EMBODIMENT

With reference now to the figures, FIG. 1 is a pictorial representation of a data processing system in which the present invention may be implemented. Networked data processing system 100 is a network of computers in which the present invention may be implemented. Networked data processing system 100 contains a network 102, which is the medium used to provide communications links between various devices and computers connected together within networked data processing system 100. Network 102 may include wireline connections, such as copper wire or fiber optic cables, and wireless connections, such as cellular telephone connections. Also, the connections for network 102 may be either permanent, such as with a dedicated line, and/or temporary, such as connections made through dial up telephone connections.

In the depicted example, a server 104 is connected to network 102 along with storage unit 106. In addition, clients 108, 110, and 112 also are connected to network 102. These clients 108, 110, and 112 may be, for example, personal computers or network computers. For purposes of this application, a network computer is any computer, coupled to a network, which receives a program or other application from another computer coupled to the network. In the depicted example, server 104 provides data, such as boot files, operating system images, and applications to clients 108-112. Clients 108, 110, and 112 are clients to server 104. In a multi-tier networked environment, networked applications are provided in which a portion of the application is located on a server, such as server 104 and another portion of the application is located on a client, such as client 108. In this implementation, the client is considered a first tier system while the server is considered a second tier system.

Networked data processing system 100 may include additional servers, clients, and other devices not shown. In the depicted example, networked data processing system 100 is the Internet with network 102 representing a worldwide collection of networks and gateways that use the TCP/IP suite of protocols to communicate with one another. At the heart of the Internet is a backbone of high-speed data communication lines between major nodes or host computers, consisting of thousands of commercial, government, educational, and other computer systems, that route data and messages. Of course, networked data processing system 100 also may be implemented as any number of different types of networks, such as, for example, an intranet or a local area network.

FIG. 1 is intended as an example, and not as an architectural limitation for the purposes of the present invention. For example, network 102 may use other hardware devices, such as, plotters, optical scanners, and the like in addition or in place of the hardware depicted in FIG. 1.

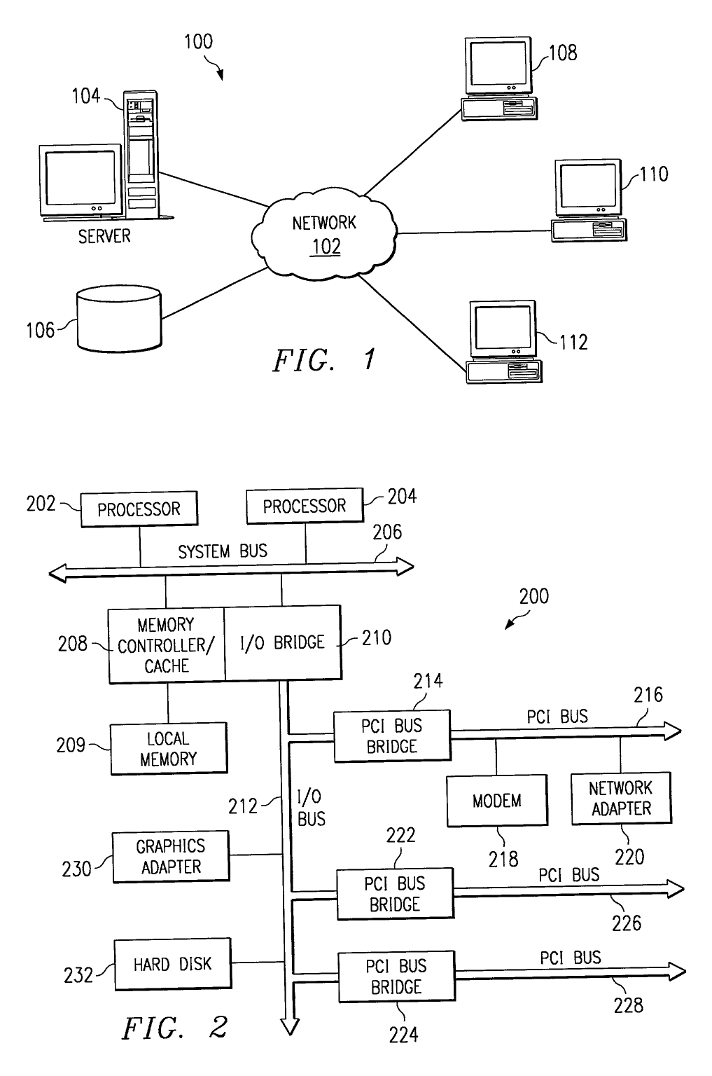

FIG. 2 is a block diagram of a data processing system that may be implemented as a server in accordance with a preferred embodiment of the present invention. FIG. 2 is an example of a server, such as, for example, server 104 in FIG. 1. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems 218 and 220 may be connected to PCI bus 216. Typical PCI bus implementations will support four PCI expansion slots or add-in connectors. Communications links to network computers 108-112 in FIG. 1 may be provided through modem 218 and network adapter 220 connected to PCI local bus 216 through add-in boards.

Additional PCI bus bridges 222 and 224 provide interfaces for additional PCI buses 226 and 228, from which additional modems or network adapters may be supported. In this manner, server 200 allows connections to multiple network computers. A memory mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drive and the like also may be used in addition or in place of the hardware depicted. The depicted example is not meant to imply architectural limitations with respect to the present invention.

The data processing system depicted in FIG. 2 may be, for example, an IBM RISC/System 6000 system, a product of International Business Machines Corporation in Armonk, N.Y., running the Advanced Interactive Executive (AIX) operating system.

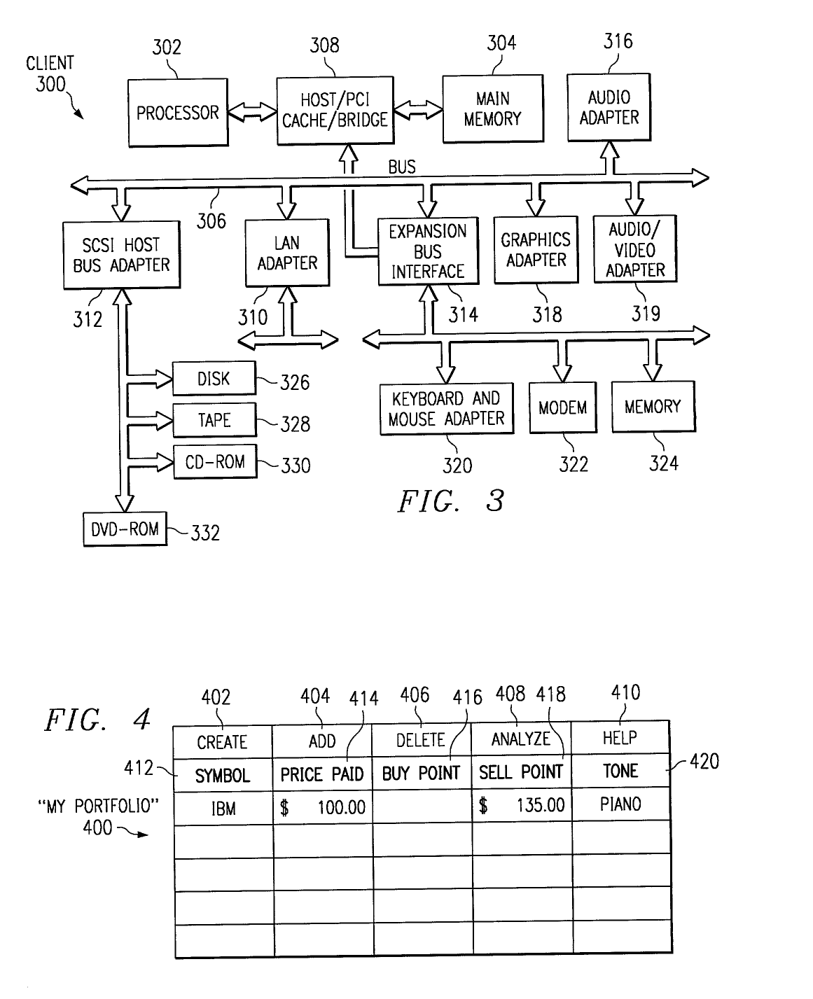

FIG. 3 is a block diagram of a data processing system that may be implemented as a client in accordance with a preferred embodiment of the present invention. Data processing system 300 employs a peripheral component interconnect (PCI) local bus architecture. Although the depicted example employs a PCI bus, other bus architectures such as Micro Channel and ISA may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter (A/V) 319 are connected to PCI local bus 306 by add-in boards inserted into expansion slots. Expansion bus interface 314 provides a connection for a keyboard and mouse adapter 320, modem 322, and additional memory 324. SCSI host bus adapter 312 provides a connection for hard disk drive 326, tape drive 328, CD-ROM drive 330, and digital video disc read only memory drive (DVD-ROM) 332 in the depicted example. Typical PCI local bus implementations will support three or four PCI expansion slots or add-in connectors.

An operating system runs on processor 302 and is used to coordinate and provide control of various components within data processing system 300 in FIG. 3. The operating system may be any available operating system, such as, for example, AIX, which is available from International Business Machines Corporation. An object oriented programming system such as Java may run in conjunction with the operating system and provides calls to the operating system from Java programs or applications executing on data processing system 300. Instructions for the operating system, the object-oriented operating system, and applications or programs are located on storage devices, such as hard disk drive 326 and may be loaded into main memory 304 for execution by processor 302.

Those of ordinary skill in the art will appreciate that the hardware in FIG. 3 may vary depending on the implementation. For example, other peripheral devices, such as optical disk drives and the like may be used in addition to or in place of the hardware depicted in FIG. 3. The depicted example is not meant to imply architectural limitations with respect to the present invention. For example, the processes of the present invention may be applied to a multiprocessor data processing system.

The present invention provides a method, apparatus, and computer implemented instructions for tracking a wide variety of investment vehicles, such as, for example, equities, bonds, certificate of deposits, annuities, and the like. A mechanism is provided to annunciate the current performance of the investment vehicles so that visually impaired and visually occupied users may track their investment vehicles by assigning different sounds, for example different Musical Instrument Digital Interface (MIDI) sounds to attributes of different investment vehicles. MIDI is a standard for connecting, for example, musical instruments, synthesizers, computer and the like. The current performance of the investment vehicle may be, for example, a value of the investment vehicle. The value of the investment vehicle may be an increase in value of the investment vehicle, a decrease in value of the investment vehicle or no change in value of the investment vehicle. The value of the investment vehicle may be either in fractions or decimal form. By assigning these MIDI sounds to the performance of an investment vehicle, a user may receive an audible indication as to the investment vehicle's performance parameters. For example, a user may specify a high pitch sound if an investment vehicle, for example, increases and may specify alternate sounds, for example, a “drum roll” if an investment vehicle achieves a user specified target price.

The present invention provides a mechanism for which a user may define options for tracking investment vehicles and for setting audible indications for notification of an investment vehicle's performance. The present invention may track investment vehicles listed on major markets which give a broad indication of how a market performs as a whole and investment vehicles not publicly traded. The present invention may also track sectors of a market, such as, for example, a utility sector, an airline sector, a manufacturing sector and the like. Also, the present invention may track reported market indexes in which give a broad indication of how a market is performing as a whole.

As a further example, a user may have, for example, three investment vehicles that the user is interested in tracking. The user would prefer to know how these three investment vehicles perform during trading hours. With reference to a first investment vehicle, the user may assign a piano tone, for a second investment vehicle the user may assign a different percussion tone and for a third investment vehicle the user may assign a woodwind tone. The user, in addition, may also assign high and low “target” prices for each tracked investment vehicle. Associated with the high and low “target” price for an investment vehicle, may be a whistle tone for the first investment vehicle, a drum roll for the second investment vehicle and a saxophone tone for the third investment vehicle. After inputting this information, the user may begin to track the performance of the chosen investment vehicles with the aid of audible updates. Based on the input specified by the user, the user will be sent the audible updates when the investment vehicle reaches one of the chosen criteria. The audible updates alerting a user of the performance of an investment vehicle may be transmitted through a cellular telephone, a personal digital assistant, a personal computer, a notebook computer, and any type of paging device which may be capable of emitting a plurality of sounds.

FIG. 4 is an exemplary portfolio for establishing investment vehicle tracking parameters to be used in the tracking of the performance of an investment vehicle in accordance with a preferred embodiment of the present invention. The present invention is an application that uses settings which may be specified by a user to analyze investment vehicle performance. User settings may be made in a section called “My Portfolio” 400. “My Portfolio” 400 may be a section in which a user specifies characteristics to be associated with, for example, tracking of investment vehicles. With “My Portfolio” 400 a user may define a plurality of investment vehicles to be mentioned, investment vehicle attributes, desired range for analysis and assignment of various sounds and volumes to the defined investment vehicle attributes which are specified. In addition, a user may specify target prices and assign sounds to be transmitted whenever these investment vehicle target prices are reached. For example, if a user has investment vehicle A that is currently valued at, for example, $100/share, and the user would like to sell investment vehicle A if investment vehicle A reaches $110/share, the user may define a special sound and/or volume to be associated with investment vehicle A reaching $110/share. For example, the special sound may be a whistle, a chord, a drum roll and the like, to indicate that this target price has been reached. Conversely, if the user is interested in, but does not own, investment vehicle B which is currently valued at $50/share, the user may define a special sound and/or volume to be associated with investment vehicle B reaching $35/share, at which point the user may want to purchase investment vehicle B. In such a situation, the user may associate a contrasting sound and/or volume to be transmitted when investment vehicle B reaches this target purchase price.

When the market indicator of the present invention is installed, a user may be prompted to define the investment vehicles and investment vehicle characteristics to be announced. When an investment vehicle characteristic of the defined investment vehicle is reached, a sound will be transmitted alerting the user of this fact. A user may be prompted by, for example, a wizard which may ask the user various questions relating to initial set up or revision of the investment vehicles, investment vehicle characteristics and associated sounds. For example, the wizard may ask the user, for example, the name or market symbol of the investment vehicle to be tracked, the purchase price of the investment vehicle, the sound to be associated with the investment vehicle, and the pitch of the sound. The wizard may also ask the user the target buying or selling price of the investment vehicle, the sound to be transmitted when the investment vehicle reaches, for example, the target buying or selling price and the type of sound to be transmitted when, for example, the target buying or selling price is reached.

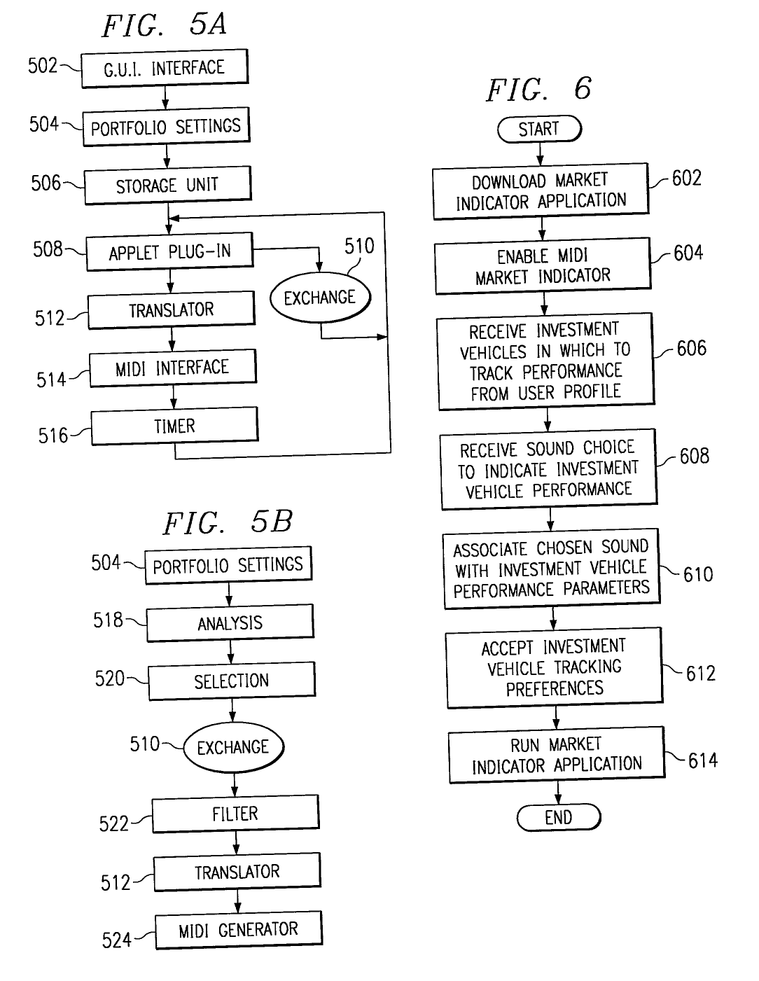

In this example, “My Portfolio” 400 may contain menu items such as, for example, Create 402, Add 404, Delete 406, Analyze 408 and Help 410. Create 402 establishes a new “My Portfolio”. At any time new investment vehicles may be added to “My Portfolio” 400. Additional investment vehicles are added to “My Portfolio” 400 by the use of Add 404. When Add 404 is chosen, a wizard may appear and direct the user for necessary information for additional investment vehicles. In addition, at any time an existing investment vehicle listed in “My Portfolio” 400 may be removed by Delete 406. Delete 406 may immediately remove investment vehicles listed in “My Portfolio” 400. Analyze 408 may take the input information regarding one or more investment vehicles listed in “My Portfolio” 400 and associate a sound with the investment vehicle. Analyze 408 is described in further detail in FIG. 5B. Help 410 may assist the user in using the functions of “My Portfolio” 400.

Furthermore, any type of sound may be associated with an investment vehicle, a group of investment vehicles, investment vehicles in a specific industry, and the like. For example, the user may want to track the performance of the utility sector of an exchange. The user may enter the utility sector and assign a sound to the performance of the sector. In addition, the sounds that may be associated with an investment vehicle's performance may consist of an unlimited array of sounds and also may allow two or more sounds to be used in concert with a specific investment vehicle. For example, a user may want to track an investment vehicle's performance with the use of a constant high pitched whistle sound and a intermittent low pitched bass sound both being transmitted at the same time. Any number of sounds may be used together for a specific investment vehicle, investment vehicle sector or market index. Furthermore, the user may define sectors of a market or a certain market index in which to track performance using the present invention. The market may be, for example, a major stock exchange and an over the counter market.

FIGS. 5A and 5B are block diagrams illustrating a process for annunciating performance of an investment vehicle in accordance with a preferred embodiment of the present invention. For example, a user may be a visually impaired user which has been trying to get involved in the markets for a period of time. However, because of the strain of analyzing and tracking investment vehicles along with the fact that most readily available information on specific investment vehicles is in textual form, the user has not progressed very far in the effort to get involved in investment vehicle buying and selling. However, with the aid of the present invention, the user is allowed to keep track of investment vehicle performance using a plurality of predetermined sounds.

In FIG. 5A, a user may establish investment vehicle performance tracking parameters with the aid of graphical user interface 502. The user may establish or update portfolio settings 504, such as illustrated in “My Portfolio” 400 in FIG. 4. The portfolio settings may define a number of investment vehicles, investment vehicle attributes, desired range for analysis and assignment of various sounds and volumes to the defined investment vehicle attributes. After portfolio settings 504 have been established, they are sent to storage unit 506. The storage of portfolio settings 504 may be on an internal storage device or stored externally. Queries are made to exchange 510 by applet plug-in 508 based on portfolio settings 504. Investment vehicle prices and investment vehicle performance parameters are sent to applet plug-in 508 from exchange 510. Translator 512 checks the investment vehicle prices and investment vehicle performance parameters against portfolio settings 504 and selects a corresponding MIDI sound as defined in “My Portfolio” 400 in FIG. 4. MIDI interface 514 receives the information regarding the sound associated with the investment vehicle and generates the sound. Timer 516 is activated and a time signal is sent to applet plug-in 508 to make periodic queries to exchange 510.

In FIG. 5B, the performance of the investment vehicle is analyzed. Portfolio settings 504 are sent to analysis engine 518. Analysis engine 518 takes the portfolio settings 504 and associates the setting with a particular investment vehicle. Selection 520 selects a model to be used in the analysis. For example, selection 520 may select a price to earnings ratio, a 52 week high for the investment vehicle, a 52 week low for the investment vehicle, and the like in selecting the model. Information from selection 520 may be used to query exchange 510 for a selected model. Information from exchange 510 is filtered to eliminate unwanted information, such as, for example, information which has not changed since a last update, redundant information, and the like. Information which is sent through filter 522 may be price to earnings ratios, share yields, 52 week high or low prices for the investment vehicle. Translator 512 then uses the filtered information to select appropriate sounds to be played in accordance with performance of an investment vehicle previously selected to be tracked. MIDI generator 524 uses the information from translator 512 to transmit the portrait that matches the performance of the investment vehicle and announces the stock name in an audible fashion.

FIG. 6 is a flowchart illustrating selection of investment vehicles and audible performance indicators in accordance with a preferred embodiment of the present invention. In this example, the operation starts by downloading a market indicator application (step 602). The market indicator may be downloaded off a data processing system, such as, for example the Internet, or may be stored and downloaded off a storage device, such, as for example, a floppy disk, or CD-ROM. The MIDI market indicator application is then enabled (step 604). The market indicator may be enabled by specifying criteria for annunciating the performance of an investment vehicle when the investment vehicle achieves a user's target price. Furthermore, the market indicator may be enabled by associating a sound with an investment vehicle's price/earnings ratio, a dividend, shares owned by the user, and the like. Then the investment vehicles for which performance is tracked are received from a portfolio setting, such as, for example, portfolio setting 504 in FIG. 5 (step 606). A sound choice to indicate investment vehicle performance is received (step 608). A chosen sound is associated with investment vehicle performance parameters (step 610). Investment vehicle performance tracking parameters are then accepted (step 612). Then the market indicator application is run to alert a user of the performance of chosen investment vehicles (step 614) and thereafter the operation ends.

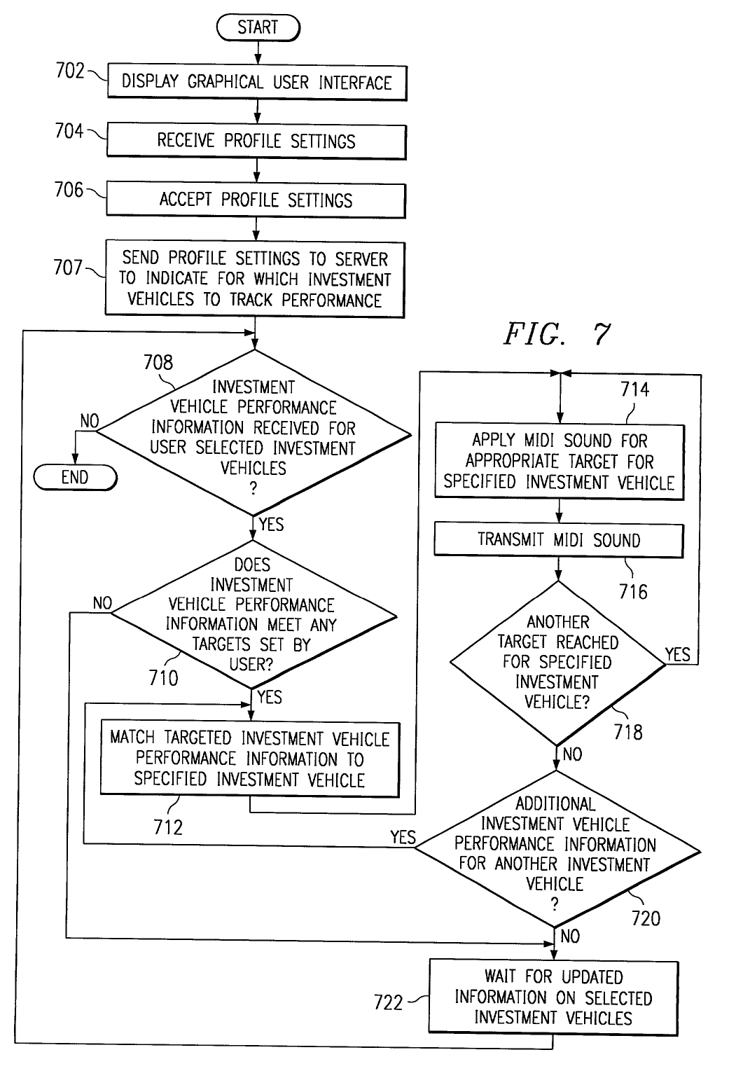

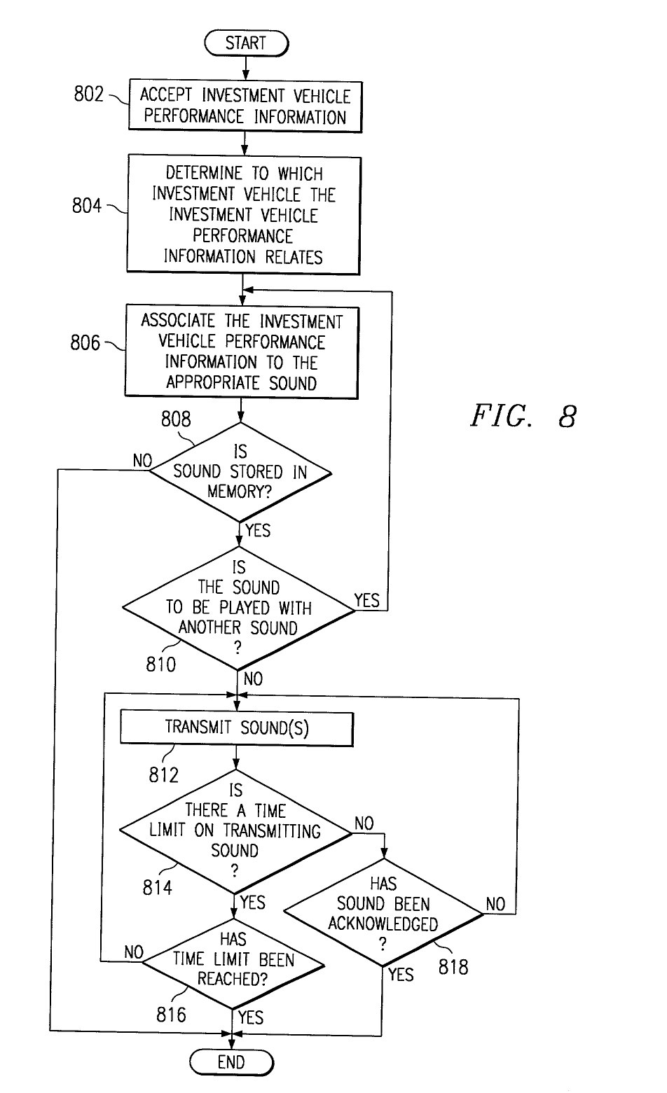

FIG. 7 is a flowchart illustrating a process for annunciating investment vehicle performance in accordance with a preferred embodiment of the present invention. In this example, the operation begins by displaying a graphical user interface (step 702). The graphical user interface may be used to specify investment vehicles in which performance is to be tracked, sounds associated with target prices of the investment vehicle when such a target price is reached and the type of performance tracking. For example, performance tracking may be an evaluation performance tracking of an investment vehicle which tracks a low target price and a high target price for the investment vehicle. In addition an analysis performance tracking may be made which tracks, for example, the price/earnings ratio of an investment vehicle a declared dividend of the investment vehicle or rate of return on investment of the investment vehicle. A sound is associated with each evaluation or analysis investment vehicle performance target reached for each investment vehicle defined by a user. Portfolio settings from a graphical user interface are received (step 704) and accepted (step 706). The portfolio settings are then sent to a server, for example, server 200 in FIG. 2, to indicate which investment vehicles for which performance are to be tracked. In order to avoid constant and non-applicable investment vehicle performance information being sent, the server, from which the investment vehicle performance is transmitted, filters out all data associated with non-selected investment vehicles. Then a determination is made as to whether or not investment vehicle performance information is received for user selected investment vehicles (step 708). If investment vehicle performance information is not received for user selected investment vehicles (step 708: NO), the operation terminates. If investment vehicle performance information is received for user selected investment vehicles (step 708: YES), a determination is made as to whether or not the investment vehicle performance information meets a target as set by the user (step 710).

If the investment vehicle performance information does not meet a target as set by the user (step 710: NO), then updated information on selected investment vehicles is awaited (step 722). If investment vehicle performance information does meet a target as set by the user (step 710: YES), then the targeted investment vehicle performance information is matched to a specific investment vehicle (step 712). A MIDI sound is applied to the appropriate target for the specified investment vehicle (step 714). The MIDI sound is then transmitted (step 716). Then a determination is made as to whether or not another target is reached for the specified investment vehicle (step 718). If another target is reached for the specified investment vehicle (step 718: YES), then the operation returns to step 714 in which a MIDI sound is applied to the appropriate target for the specified investment vehicle. If another target is not reached for the specified investment vehicle (step 718: NO), then a determination is made as to whether or not there is additional investment vehicle performance information for another investment vehicle (step 720). If there is additional investment vehicle performance information for another investment vehicle (step 720: YES), then the operation returns to step 712 in which the investment vehicle performance information is matched to the specific investment vehicle. If there is not additional investment vehicle performance information for another investment vehicle (step 720: NO), then the operation returns to step 722 in which updated information on selected investment vehicles is awaited.

FIG. 8 is a flowchart illustrating a process for selecting matching audible signatures in accordance with a preferred embodiment of the present invention. In this example, the operation starts by accepting the investment vehicle performance information (step 802). Then a determination is made as to which investment vehicle the investment vehicle performance information relates (step 804). The investment vehicle performance information is then associated with the appropriate sound to announce the investment vehicle performance information (step 806). Then a determination is made as to whether or not the sound is stored in memory (step 808). If the sound is not stored in memory (step 808: NO), the operation terminates. If the sound is stored in memory (step 808: YES), then a determination is made as to whether or not the sound is to be played simultaneously with another sound (step 810).

If the sound is to be played simultaneously with another sound (step 810: YES), then the operation returns to step 806 in which the investment vehicle performance information is associated with the appropriate sound. If the sound is not to be played with another sound (step 810: NO), then the sound(s) is/are transmitted (step 810). Then a determination is made as to whether or not there is a time limit on transmitting the sound(s) (step 814). If there is a time limit on transmitting the sound(s) (step 814: YES), then a determination is made as to whether or not the time limit has been reached (step 816). If the time limit has not been reached (step 816: NO), then the operation returns to step 812 in which the sound(s) is/are transmitted. If the time limit has been reached (step 816: YES), the operation terminates.

Returning to step 814, if there is not a time limit on transmission of the sound(s) (step 814: NO), then a determination is made as to whether or not the transmission of the sound(s) has been acknowledged (step 818). If the transmission of the sound(s) has been acknowledged (step 818: YES), the operation terminates. If the transmission of the sound(s) has not been acknowledged (step 818: NO), the operation returns to step 812 in which the sound(s) is/are transmitted.

Thus, the present invention provides a method, apparatus, and computer implemented instructions for annunciating an investment vehicle's performance by assigning an audible indication of the investment vehicle's performance to assist those with impaired vision as well as to provide audio channel information to those whose visual attention may be previously occupied at the time the information is delivered. Based on investment vehicle performance indicator portfolio settings, the application may track the investment vehicles the user has specified and provide an audible transmission through an audio portrait, e.g. increasing harmonic sounds as the value of investment vehicle rises or decreasing chaotic sounds as the value of the investment vehicle declines. The mechanism of the present invention allows for using market data to generate a musical portrait of an investment vehicle's performance.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method for annunciating performance of an investment vehicle within a plurality of investment vehicles in a market, the method comprising the steps of:
receiving a current performance indication of the investment vehicle within the plurality of investment vehicles;
matching the current performance indication of the investment vehicle to a predetermined audible signature; and
transmitting the predetermined audible signature based on results of the matching.

2. The method as recited in claim 1, wherein the investment vehicle within the plurality of investment vehicles includes at least one of an equity, bond, certificate of deposit, and an annuity.

3. The method as recited in claim 1, wherein the current performance indication is a value of the investment vehicle.

4. The method as recited in claim 3, wherein the value of the investment vehicle is one of an increase in value of the investment vehicle, a decrease in value of the investment vehicle and no change in value of the investment vehicle.

5. The method as recited in claim 3, wherein the value of the investment vehicle is expressed in one of a fraction format and a decimal format.

6. The method as recited in claim 1, wherein the investment vehicle within the plurality of investment vehicles is one of a publicly traded investment vehicle and a privately held investment vehicle in at least one of a major stock exchange and an over a counter stock exchange.

7. The method as recited in claim 1, wherein receiving a current performance indication of the investment vehicle within the plurality of investment vehicles is received by at least one of a buyer of the investment vehicle and a seller of the investment vehicle.

8. The method as recited in claim 1, wherein the current performance indication of the investment vehicle includes at least one of evaluating performance of the investment vehicle and analyzing performance of the investment vehicle.

9. The method as recited in claim 8, wherein evaluating performance of the investment vehicle includes at least one of criteria for buying the investment vehicle and criteria for selling the investment vehicle.

10. The method as recited in claim 9, wherein criteria for buying the investment vehicle and criteria for selling the investment vehicle includes a target price of the investment vehicle.

11. The method as recited in claim 8, wherein analyzing performance of the investment vehicle includes at least one of a price to earnings ratio of the investment vehicle, a dividend paid for a share of the investment vehicle and a rate of return on investment of the investment vehicle.

12. The method as recited in claim 1, wherein the predetermined audible signature is stored in a memory.

13. The method as recited in claim 1, wherein transmitting the predetermined audible signature is transmitted from at least one of a cellular telephone, a personal digital assistant, a personal computer, a notebook computer and a paging device.

14. The method as recited in claim 1, wherein the audible signature is a musical instrument digital interface (MIDI) standard.

15. The method as recited in claim 14, wherein the MIDI standard is a plurality of MIDI standards.

16. The method as recited in claim 1, wherein the audible signature changes pitch as the current performance of the investment vehicle changes.

17. The method as recited in claim 16, wherein the change in pitch is a higher pitch as the current performance increases and a lower pitch as the current performance decreases.

18. A data processing system comprising:
a bus system;
a communications unit connected to the bus system;
a memory connected to the bus system, wherein the memory includes a set of instructions and a plurality of predetermined audible signatures;
an output unit connected to the bus system; and
a processing unit connected to the bus system,
wherein the processing unit executes the set of instructions to receive a current performance indication of the investment vehicle within the plurality of investment vehicles from the communication unit, the processing unit matches the current performance indication of the investment vehicle, and the processing unit instructs the output unit to transmit the predetermined audible signature based on results of the matching.

19. The data processing system of claim 18, wherein the processing unit includes a plurality of processors.

20. The data processing system of claim 18, wherein a first processing unit within the plurality of processors is located at a server machine.

21. The data processing system of claim 18, wherein a second processing unit within the plurality of processors is located at a client machine.

22. A data processing system for annunciating performance of an investment vehicle within a plurality of investment vehicles in a market, comprising:
receiving means for receiving a current performance indication of the investment vehicle within the plurality of investment vehicles;
matching means for matching the current performance indication of the investment vehicle to a predetermined audible signature; and
transmitting means for transmitting the predetermined audible signature based on results of the matching.

23. The system as recited in claim 22, wherein the investment vehicle within the plurality of investment vehicles includes at least one of an equity, bond, certificate of deposit, and an annuity.

24. The system as recited in claim 22, wherein the current performance indication is a value of the investment vehicle.

25. The system as recited in claim 24, wherein the value of the investment vehicle is one of an increase in value of the investment vehicle, a decrease in value of the investment vehicle and no change in value of the investment vehicle.

26. The system as recited in claim 24, wherein the value of the investment vehicle is expressed in one of a fraction format and a decimal format.

27. The system as recited in claim 22, wherein the investment vehicle within the plurality of investment vehicles is one of a publicly traded investment vehicle and a privately held investment vehicle in at least one of a major stock exchange and an over a counter stock exchange.

28. The system as recited in claim 22, wherein receiving a current performance indication of the investment vehicle within the plurality of investment vehicles is received by at least one of a buyer of the investment vehicle and a seller of the investment vehicle.

29. The system as recited in claim 22, wherein the current performance indication of the investment vehicle includes at least one of evaluating performance of the investment vehicle and analyzing performance of the investment vehicle.

30. The system as recited in claim 29, wherein evaluating performance of the investment vehicle includes at least one of criteria for buying the investment vehicle and criteria for selling the investment vehicle.

31. The system as recited in claim 30, wherein criteria for buying the investment vehicle and criteria for selling the investment vehicle includes a target price of the investment vehicle.

32. The system as recited in claim 29, wherein analyzing performance of the investment vehicle includes at least one of a price to earnings ratio of the investment vehicle, a dividend paid for a share of the investment vehicle and a rate of return on investment of the investment vehicle.

33. The system as recited in claim 22, wherein the predetermined audible signature is stored in a memory.

34. The system as recited in claim 22, wherein transmitting the predetermined audible signature is transmitted from at least one of a cellular telephone, a personal digital assistant, a personal computer, a notebook computer and a paging device.

35. The system as recited in claim 22, wherein the audible signature is a musical instrument digital interface (MIDI) standard.

36. The system as recited in claim 35, wherein the MIDI standard is a plurality of MIDI standards.

37. The system as recited in claim 22, wherein the audible signature changes pitch as the current performance of the investment vehicle changes.

38. The system as recited in claim 37, wherein the change in pitch is a higher pitch as the current performance increases and a lower pitch as the current performance decreases.

39. A first computer system having means for annunciating performance of an investment vehicle from the first computer to a second computer communicatively connected to the first computer over a network, comprising:
means for receiving, from the first computer, a current performance indication of the investment vehicle;
means for matching, by the second computer, the current performance indication of the investment vehicle to a predetermined audible signature; and
means for transmitting the predetermined audible signature based on results of the matching by the second computer.

40. The computer system of claim 39, wherein the means for matching the current performance indication of the investment vehicle to a predetermined audible signature is performed by the first computer.

41. A computer program product in a computer-readable medium for annunciating performance of an investment vehicle within a plurality of investment vehicles in a market, comprising:
instructions for receiving a current performance indication of the investment vehicle within the plurality of investment vehicles;
instructions for matching the current performance indication of the investment vehicle to a predetermined audible signature; and
instructions for transmitting the predetermined audible signature based on results of the matching.

42. The computer program product as recited in claim 41, wherein the current performance indication is a value of the investment vehicle.

43. The computer program product as recited in claim 41, wherein the current performance indication of the investment vehicle includes at least one of evaluating performance of the investment vehicle and analyzing performance of the investment vehicle.

44. The computer program product as recited in claim 43, wherein evaluating performance of the investment vehicle includes at least one of criteria for buying the investment vehicle and criteria for selling the investment vehicle.

45. The computer program product as recited in claim 41, wherein the audible signature is a musical instrument digital interface (MIDI) standard.

46. The computer program product as recited in claim 45, wherein the MIDI standard is a plurality of MIDI standards.

47. The computer program product as recited in claim 41, wherein the audible signature changes pitch as the current performance of the investment vehicle changes.

48. The computer program product as recited in claim 47, wherein the change in pitch is a higher pitch as the current performance increases and a lower pitch as the current performance decreases.
